(19) United States
(12) Patent Application Publication
(10) Pub. No.: US 2021/0362303 A1
(43) Pub. Date: Nov. 25, 2021

(54) WRENCH

(71) Applicant: Wang-Lien Chang, New Taipei City (TW)

(72) Inventor: Wang-Lien Chang, New Taipei City (TW)

(21) Appl. No.: 16/881,492

(22) Filed: May 22, 2020

(51) Int. Cl. B25B 13/48; B25B 17/02; B25G 1/00

(52) U.S. Cl. CPC B25B 13/481; B25G 1/005; B25B 17/02

(57) ABSTRACT

A wrench includes a main rod, a rotating rod and a head portion. One end of the rotating rod is fixed to the main rod. The head portion includes an accommodating element, a sleeve mount, a driven gear and a driving gear. The accommodating element has a side opening. A periphery of the side opening extends outward to form an engaging portion. The main rod is rotatably mounted through the engaging portion. The sleeve mount is rotatably mounted in the accommodating element. The driven gear is fixed to the sleeve mount and is located in the accommodating element. The driving gear is fixed to the rotating rod and engaged with the driven gear. The sleeve mount is driven to tighten or loosen a nut by rotating the main rod to reduce an operating space for the wrench.

### BACKGROUND OF THE INVENTION

### 1. Field of the Invention

The present invention relates to a wrench, especially to a wrench that has a sleeve driven by rotating the handle.

### 2. Description of the Prior Arts

A conventional ratchet wrench is a common tool for daily use. The ratchet wrench has a handle and a head. The handle is a rod. The head is mounted on an end of the handle. The head has an inner space. A ratchet, a sleeve mount, and a switching knob are mounted in the head. One end of the ratchet is connected to one end of the sleeve mount, and the sleeve mount protrudes from one end of the head. Another end of the ratchet is connected to the switching knob. The switching knob protrudes from another end of the head. One end of a sleeve can be connected to the sleeve mount, and another end of the sleeve can be used for connecting a nut which is to be tightened or loosened. The user turns the switching knob to select between a tightening mode and a loosening mode, and then the user can swing the handle to rotate the wrench around the head within a specific angle to tighten or loosen the nut.

However, in order to operate the conventional ratchet wrench, sufficient operating space must be kept around the nut for the handle to be swung. Therefore, it would be difficult, if not impossible, to operate the conventional ratchet wrench when the nut is located in a tight space where the handle can hardly be swung. In other words, when the nut is in a tight space, a swing angle, at which the handle can be swung each time inside the tight space, of the handle is very limited. Because a rotating angle of the sleeve is dependent on the swing angle of the handle, the user needs to swing the handle much more times in order to tighten or loosen the nut, which makes operating the conventional wrench time consuming and induces more labor cost. Therefore, the structure of the ratchet wrench needs to be improved.

### SUMMARY OF THE INVENTION

The main objective of the present invention is to provide a wrench which the user can rotate the main rod to tighten or loosen a nut, thereby greatly reducing required operating space of the wrench and allows the wrench to be operated in a tight space.

The wrench includes a handle portion and a head portion. The handle portion includes a main rod and a rotating rod. Two opposite ends of the rotating rod are respectively a first end and a second end, and the first end is fixed to the main rod. The head portion is connected to the handle portion, and includes an accommodating element, a sleeve mount, a driven gear and a driving gear. The accommodating element has an internal space, a front opening, a rear opening, a side opening and an engaging portion. The front opening and the rear opening are respectively formed on two ends of the accommodating element. The side opening is formed through a side wall of the accommodating element. The engaging portion extends outward from a periphery of the side opening, and is rotatably mounted around and attached to the main rod. The sleeve mount is rotatably mounted through the rear opening and the front opening of the accommodating element. The driven gear is mounted around the sleeve mount and located in the internal space of the accommodating element. The driven gear is a bevel gear. The driving gear is mounted around the second end of the rotating rod and located in the internal space of the accommodating element. The driving gear is a bevel gear engaged with the driven gear.

The advantage of the present invention is that a user tightens or loosens the nut by rotating the main rod of the handle portion. An operating space required by the present invention is greatly reduced compared to an operating space required by a conventional wrench whose handle must be swung to operate. Therefore, the present invention can be used to operate the nut located in a tight space as long as the sleeve mount can be connected to the nut.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wrench in accordance with the present invention;

FIG. 2 is an exploded perspective view of the first embodiment of the wrench;

FIG. 3 is a cross-sectional view of the first embodiment of the wrench;

FIG. 4 is a partial cross-sectional view of the first embodiment of the wrench;

FIG. 5 is a perspective view of a second embodiment of a wrench in accordance with the present invention;

FIG. 6 is an exploded perspective view of the second embodiment of the wrench;

FIG. 7 is a partial cross-sectional view of the second embodiment of the wrench;

FIG. 8 is a schematic partial cross-sectional view of the second embodiment of the wrench viewed from a different angle, showing different operating statuses of the rotating arms;

FIG. 9 is a partial cross-sectional view of the second embodiment of the wrench, showing the two rotating arms unfolded and aligned along a straight line;

FIG. 10 is a partial cross-sectional view of the second embodiment of the wrench, showing the two rotating arms unfolded and a stopping portion of a positioning element engaged with the two rotating arms;

FIG. 11 is a perspective view of the second embodiment of the wrench, showing the two rotating arms aligned along the straight line; and

FIG. 12 is a schematic side view of a third embodiment of a wrench in accordance with the present invention.

### DETAILED DESCRIPTION OF THE PREFERRED EMBODIMENTS

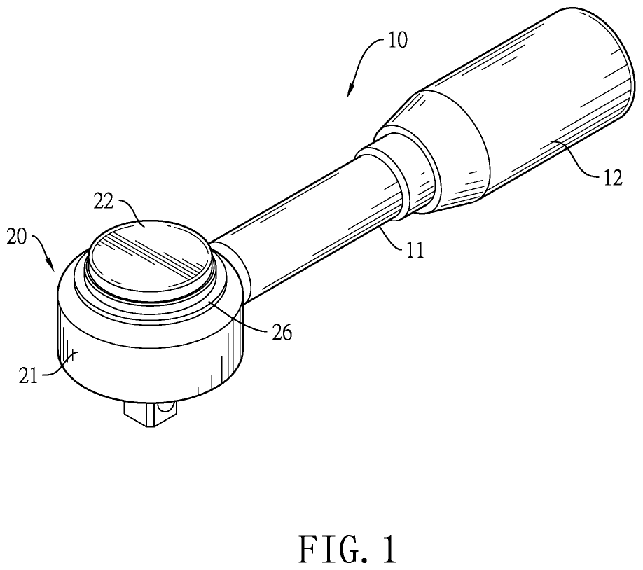

With reference to FIG. 1, a first embodiment of a wrench in accordance with the present invention includes a handle portion 10 and a head portion 20.

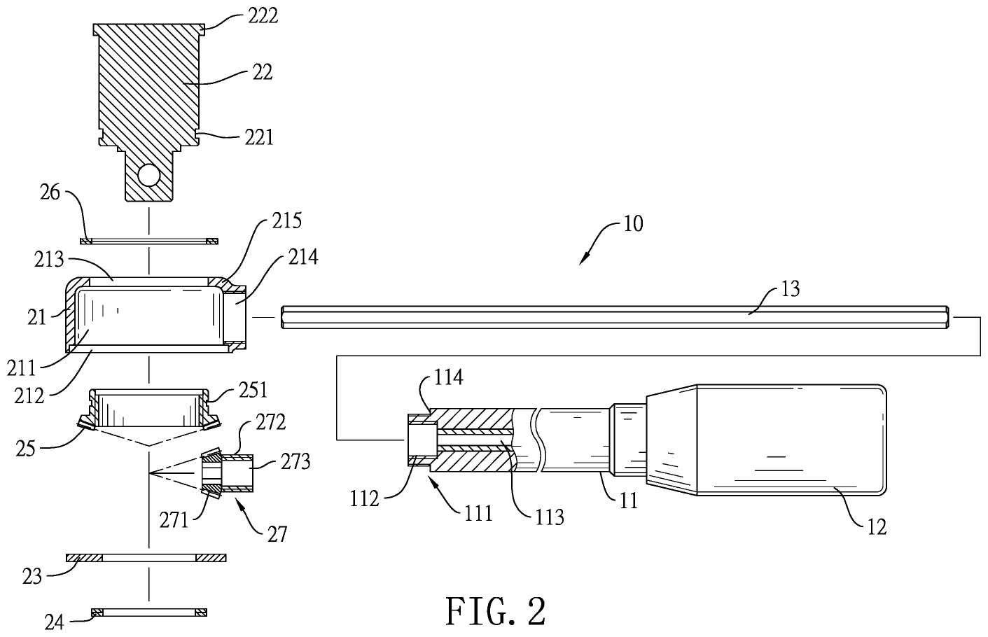

With reference to FIG. 1 and FIG. 2, the handle portion 10 includes a main rod 11 and a rotating rod 13. Two opposite ends of the rotating rod 13 are respectively a first end and a second end. The first end of the rotating rod 13 is fixed to the main rod 11. A connecting portion 111 is formed on one end of the main rod 11. A first recess 112 is formed in an end surface of the connecting portion 111. A second recess 113 is formed in a bottom of the first recess 112. The second recess 113 is a polygonal recess. The second recess 113 extends to another end of the main rod 11. In this preferred embodiment, the second recess 113 is a polygonal recess. A locating portion 114 is annularly formed around the outer surface of the connecting portion 111. The locating portion 114 has a locating surface. The locating portion 114 is attached to the side opening 214 of the accommodating element 21. A grabbing portion 12 is connected to another end of the main rod 11. The grabbing portion 12 is located around an outer surface of the main rod 11. An outer diameter of the grabbing portion 12 is larger than an outer diameter of the connecting portion 111.

The rotating rod 13 is a polygonal rod. The rotating rod 13 corresponds to the second recess 113 in shape. One end of the rotating rod 13 is mounted in the second recess 113 and mounted through the first recess 112. An outer surface of the rotating rod 113 abuts against a mounting surface of the second recess 113. The design of the second recess 113 and the rotating rod 13 can be changed according to user needs, as long as the rotating rod 13 is fixed to the main rod 11.

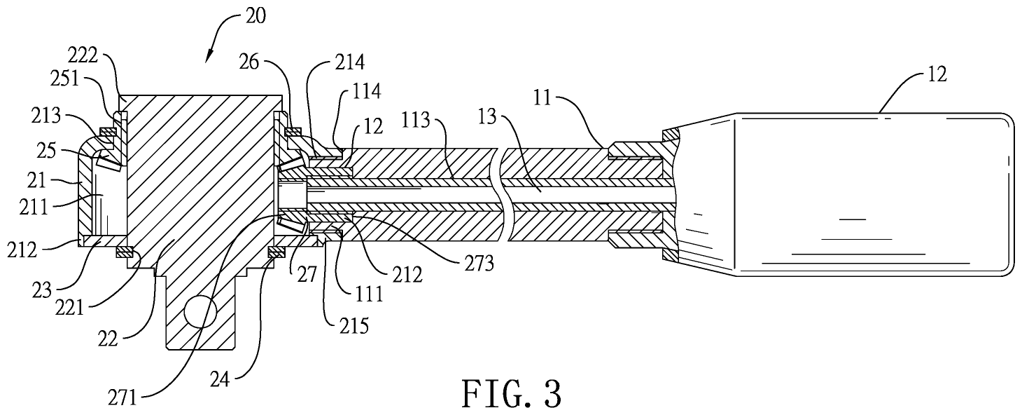

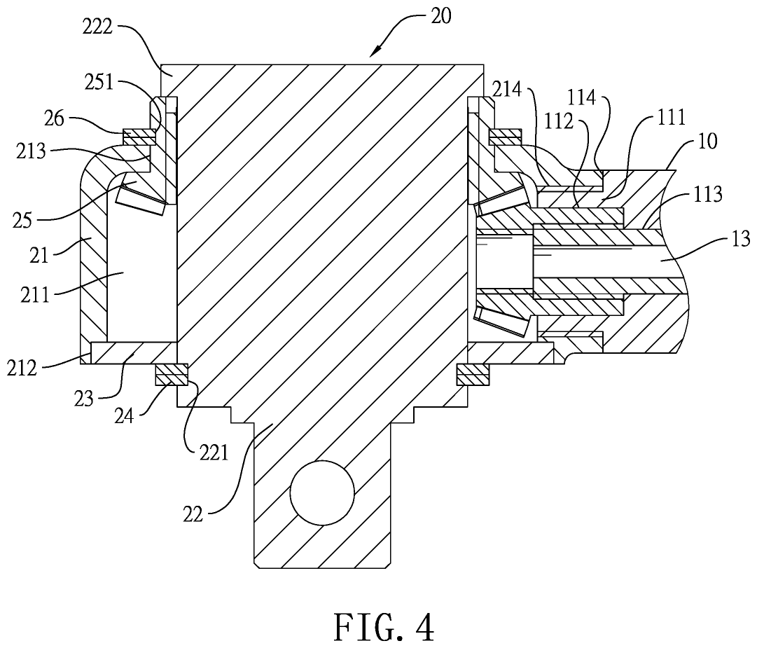

With reference FIGS. 2 to 4, the head portion 20 is connected to the handle portion 10. The head portion 20 includes an accommodating element 21, a sleeve mount 22, a front cover 23, a front positioning piece 24, a driven gear 25, a rear positioning piece 26, and a driving gear 27. The accommodating element 21 is a hollow cylinder or a hollow prism, and has an internal space 211. The accommodating element 21 includes a front opening 212, a rear opening 213 and a side opening 214. The front opening 212 and the rear opening 213 are respectively formed on two ends of the accommodating element 21. The side opening 214 is formed through a side wall of the accommodating element 21. A periphery of the side opening 214 extends outward to form the engaging portion 215, that is, the engaging portion 215 is formed on the periphery of the side opening 214. The engaging portion 215 corresponds in shape to the connecting portion 111 so that the mounting surface of the engaging portion 215 is rotatably mounted around the locating portion 114.

The sleeve mount 22 is adopted to connect a sleeve (not shown in the figures). The sleeve mount 22 is the same as a conventional sleeve mount. The sleeve mount 22 is rotatably mounted through the rear opening 213 and the front opening 212. A front positioning groove 221 and a rear protrusion 222 are formed on the sleeve mount 22. The front positioning groove 221 is annularly formed in an outer surface of the sleeve mount 22. The front positioning groove 221 is adjacent to the front opening 212. The front cover 23 is a hollow sheet. The sleeve mount 22 is mounted around the front cover 23. The front cover 23 is fixed to a periphery of the front opening 212 of the accommodating element 21. The front positioning piece 24 is a hollow sheet. The front positioning piece 24 is mounted around the front positioning groove 221. The front positioning piece 24 is attached to the front cover 23. The rear protrusion 22 is formed around the outer surface of the sleeve mount 22 and is adjacent to the rear opening 213 of the accommodating element 21.

The driven gear 25 is a bevel gear. The driven gear 25 is mounted around the sleeve mount 22 and located in the internal space 211 of the accommodating element 21. The driven gear 25 abuts against the rear protrusion 222 of the sleeve mount 22. A rear positioning groove 251 is annularly formed in an outer surface of the driven gear 25. The rear positioning groove 251 is adjacent to the rear opening 213. The rear positioning piece 26 is a hollow sheet. The rear positioning piece 26 is mounted around the rear positioning groove 251. The rear positioning piece 26 is attached to an outer surface of the accommodating element 21. The sleeve mount 22 is rotatably located in the accommodating element 21. To be precise, the sleeve mount 22 is confined in the accommodating element 21 by the front cover 23, the front positioning piece 24, the rear positioning piece 26 and the rear protrusion 222. The design of the sleeve mount 22 can be changed according to user needs, as long as the sleeve mount 22 is rotatably located in the accommodating element 21.

The driving gear 27 is a bevel gear. The driving gear 27 is mounted around the second end of the rotating rod 13 and mounted in the first recess 112. The driving gear 27 is engaged with the driven gear 25. Furthermore, the driving gear 27 includes a tooth portion 271 and a connecting portion 272. The tooth portion 271 is located on one end of the driving gear 27 and located in the internal space 211 of the accommodating element 21. The tooth portion 271 is engaged with the driven tooth 25. The connecting portion 272 is formed on another end of the driving gear 27. The connecting portion 272 is a hollow cylinder or prism. A fixing hole 273 is formed through the connecting portion 272 of the driving gear 27. The fixing hole 273 is a polygonal hole. The fixing hole 273 corresponds in shape to the rotating rod 13. An outer surface of the second end of the rotating rod 13 is fixed to an internal surface of the fixing hole 273. When the driving gear 27 is engaged with the driven gear 25, the axis of the driving gear 27 and the axis of the driven gear 25 are perpendicular to each other. When the rotating rod 13 rotates, the driving gear 27 rotates the driven gear 25 to make the sleeve mount 22 rotate.

When the present invention is in use, a sleeve (not shown in the figures) is connected to the sleeve mount 22, and then the sleeve is mounted around a nut (not shown in the figures). A user then holds the grabbing portion 12 and rotate the rotating rod 13 clockwise or counterclockwise around the axis of the rotating rod 13. When the grabbing portion 12 is rotated by the user, the grabbing portion 12 makes the rotating rod 13 rotate simultaneously and makes the driving gear 27 located on another end of the rotating rod 13 rotate simultaneously. Because the driving gear 27 is engaged with the driven gear, the driven gear 25 is rotated by the driving gear 27 to tighten or loosen the nut.

Because the user tightens or loosens the nut by rotating the grabbing portion 12 of the handle portion 10, an operating space required by the present invention is greatly reduced compared to an operating space required by a conventional wrench of which the handle must be swung to operate. Therefore, the present invention can be used to operate the nut located in a tight space as long as the sleeve mount 22 can be connected to the nut.

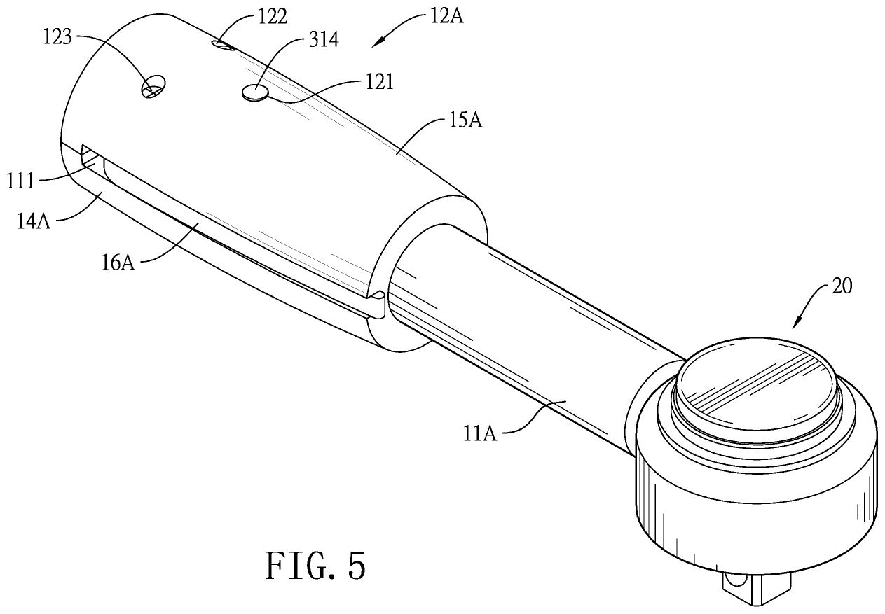

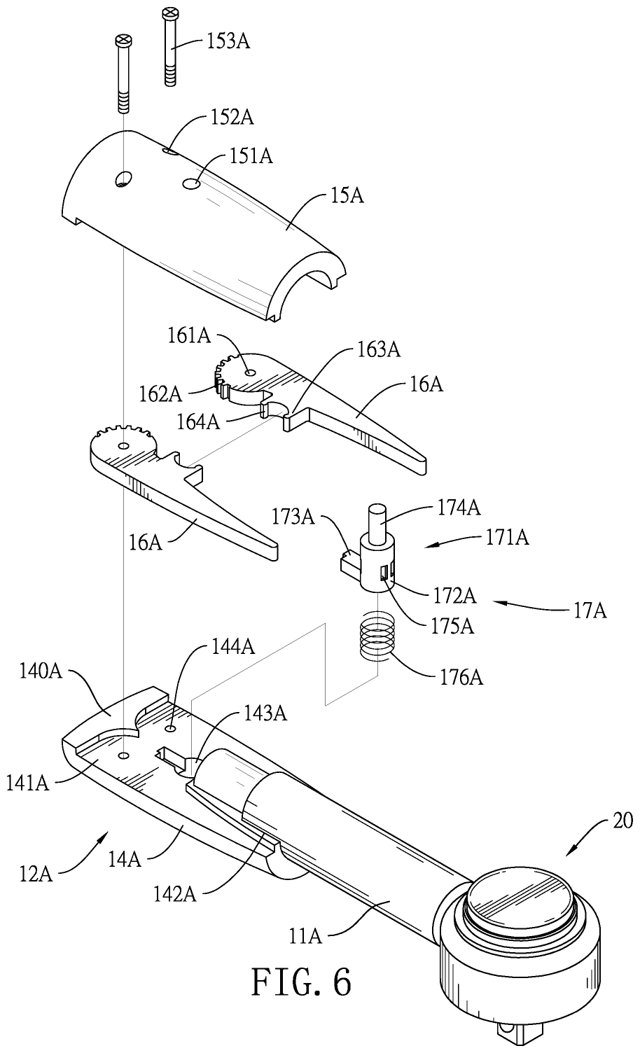

In the second embodiment, as shown in FIG. 5 and FIG. 6, a grabbing portion 12A having two rotating arms 16A can be connected to an end of the main rod 11A. The grabbing portion 12A further includes a base 14A, a cover 15A, two rotating arms 16A and a fixing assembly 17A. The base 14A is elongated and has a mounting surface 140A. A first mounting recess 141A, a second mounting recess 142A and a third mounting recess 143A are formed in the mounting surface 140A. Two screw holes 144A are formed in the base 14A and are located at a bottom of the first mounting recess 141A. An internal thread is formed in each one of the screw holes 144A. The first mounting recess 141A surrounds the opposite edges of an opening of the second mounting recess 142A, which is a stepped configuration. That is, the first mounting recess 141A is formed in the mounting surface 140A and is adjacent to the second mounting recess 142A, and two areas of the first mounting recess 141A extend along two opposite edges of the opening of the second mounting recess respectively. The first mounting recess 141A forms two arm openings on two opposite side surfaces of the base 14A.

The second mounting recess 142A is formed in the mounting surface 140A and located at one end of the base 14A. The second mounting recess 142A is formed through the base 14A to form an opening. The third mounting recess 143A is formed in the mounting surface 140A, and is located between the first mounting recess 141A and the second mounting recess 142A. Moreover, the third mounting recess 143A is located among the two rotating arms 16A and the second mounting recess 142A. The first mounting recess 141A, the second mounting recess 142A and the third mounting recess 143A communicate with each other. In a preferred embodiment, the first mounting recess 141A, the second mounting recess 142A and the third mounting recess 143A are symmetrical. However, the shapes of the mounting recesses 141A, 142A and 143A are not limited thereto, as long as the mounting recesses accommodates parts that are necessary for the present invention.

The cover 15A corresponds in shape to the base 14A. The cover 15A is selectively mounted on the mounting surface 140A of the base 14A. In the present embodiment, a through hole 151A and two locking holes 152A are formed through the cover 15A. The through hole 151A is formed in a bottom of a moving recess 154A. A position of the through hole 151A corresponds to a position of the third mounting recess 143A. Furthermore, the cover 15A has a cover surface. The moving recess 154A is formed in a surface, which faces towards the base 14A, of the cover 15A. The moving recess 154A is formed around a periphery of the through hole 151A. The moving recess 154A has a recess bottom 155A. The two locking holes 152A are formed through the cover 15A and respectively correspond in position to the two screw holes 144A. The cover 15A is fastened to the base 14A by the locking components 153A. The two locking components 153A are mounted through the two locking holes 152A respectively, and are fastened to the two screw holes 144A respectively. The locking components 153A are not limited to screws, as long as the cover 15A can be fastened to the base 14A by the locking components 153A.

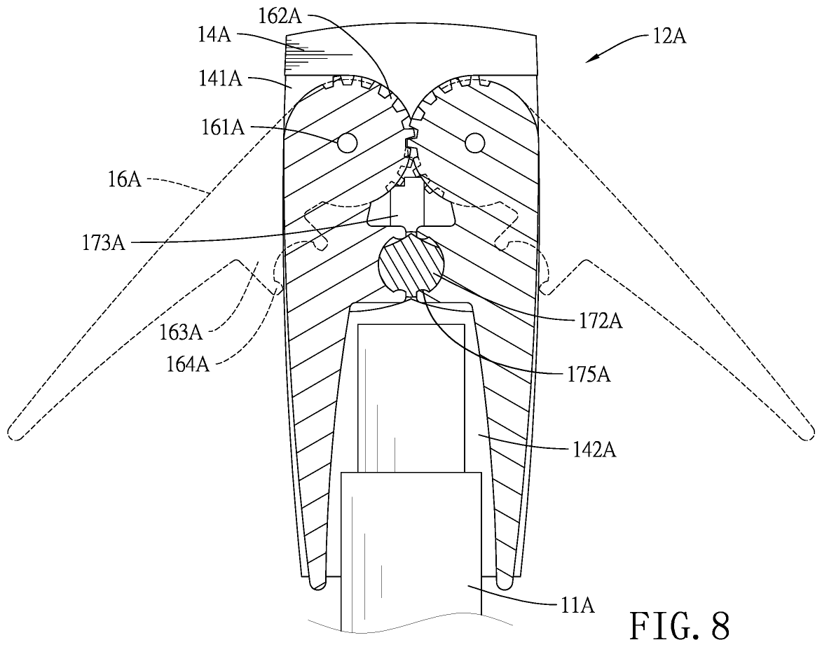

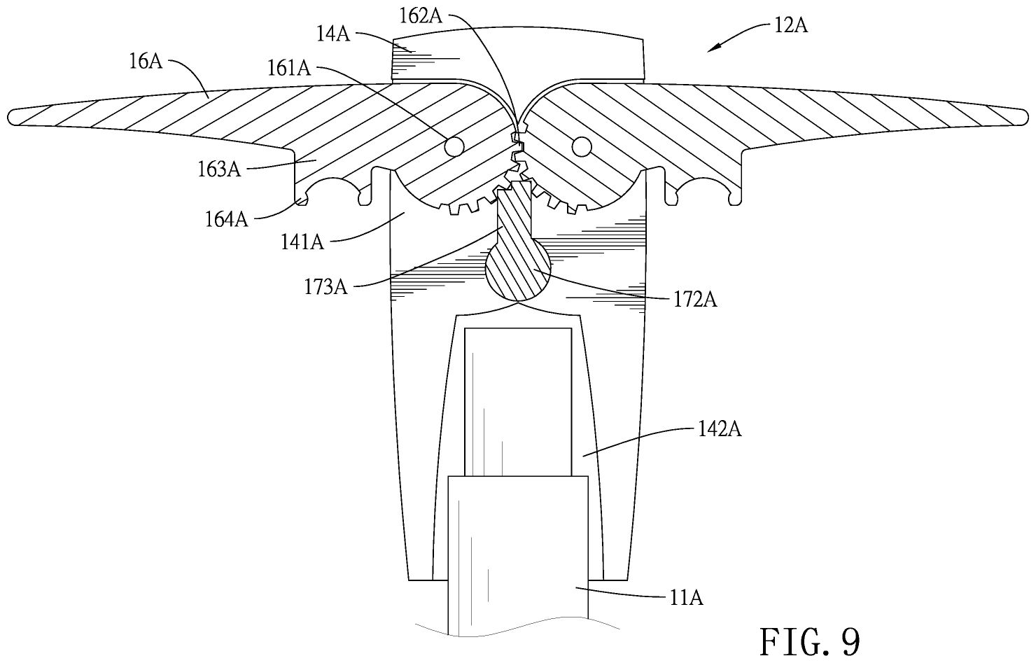

With reference to FIG. 6, FIG. 8 and FIG. 9, the two rotating arms 16A have the same shape. The two rotating arms 16A are symmetrically and pivotally mounted in the first mounting recess 141A and located between the base 14A and the cover 15A. To be precise, each one of the two rotating arms 16A has an end located between the cover 15A and the base 14A and forming a rotating hole 161A. The two locking components 153A are mounted through the two rotating holes 161A respectively to make the rotating arms 16A pivotally mounted around the locking components 153A and located in the first mounting recess 141A. The two rotating arms 16A can protrude from the first mounting recess 141A via the two arm openings or retracting into the first mounting recess 141A. In the present embodiment, the rotating arms 16A are elongated. Each one of the rotating arms 16A extends along an imaginary straight line. When the two rotating arms 16A protrude from the first mounting recess 141A, the imaginary straight line of one of the two rotating arms 16A is capable of being aligned with the imaginary straight line of another one of the two rotating arms 16A. That is, the two rotating arms 16A are capable of pivoting outwardly to form a straight line.

One end of each one of the rotating arms 16A is adjacent to one end of another one of the rotating arms 16A. Each one of said two ends of the two rotating arms 16A has multiple coupling teeth 162A. The coupling teeth 162A are formed along a periphery of the corresponding rotating arm 16A. The coupling teeth 162A of one of the two rotating arms 16A engage with the coupling teeth 162A of another one of the two rotating arms 16A. Each rotating arm 16A extends away from the corresponding coupling teeth 162A. The cross-sectional area of each one of the two rotating arms 16A gradually decreases toward a direction away from the corresponding coupling teeth 162A. The structure of the rotating arm 16A can be changed according to user needs, as long as the rotating arms 16A can pivot. Two engaging portions 163A are respectively formed on opposite sides of the two rotating arms 16A. The shape of the engaging portion 163A is a “C”. Two hook portions 164A protrude from the two ends of each engaging portion 163A respectively. Each hook portion 164A is a block formed by an end of the corresponding engaging portion 163A.

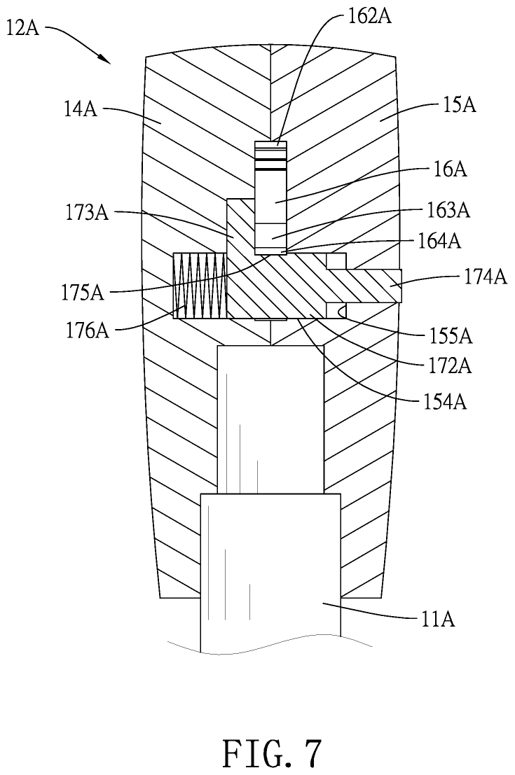

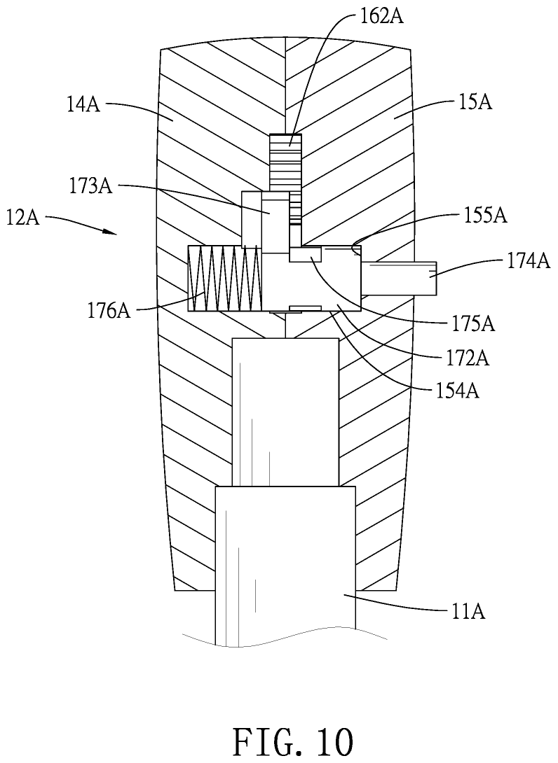

With reference to FIG. 6, FIG. 7 and FIG. 10, the fixing assembly 17A includes a positioning element 171A and a resilient element 176A. The positioning element 171A includes a body 172A, a stopping portion 173A and a pressing portion 174A. The body 172A is a cylinder or a prism. Multiple engaging grooves 175A are formed in a surface of the body 172A. The engaging grooves 175A correspond in shape to the hook portions 164A, so that the hook portions 164A can be engaged to the engaging grooves 175A respectively. The stopping portion 173A is a block. The stopping portion 173A protrudes from a side wall of one end of the body 172A and extends toward a middle of the two rotating arms 16A where the coupling teeth 162A are formed.

The pressing portion 174A is a cylinder or a prism, and is formed on another end of the body 172A. In the present embodiment, the positioning element 171A is mounted in the third mounting recess 143A and the moving recess 154A. The positioning element 171A corresponds in shape to the third mounting recess 143A and the moving recess 154A.

The resilient element 176A is a spring and is mounted between the positioning element 171A and a bottom of the third mounting recess 143A. The resilient element 176A presses the positioning element 171 against the base 14A. To be precise, the end of the positioning element 171A having the stopping portion 173A abuts against the resilient element 176A. The pressing portion 174A is mounted through the through hole 151A of the cover 15A, so that the positioning element 171A can be moved in the third mounting recess 143A and the moving recess 154A by pressing against the resilient element 176A or being driven by the resilient element 176A. The movement of the positioning element 171A allows the stop portion 173A to be aligned in a same plane with the two rotating arms 16A or to be separated from the two rotating arms 16A.

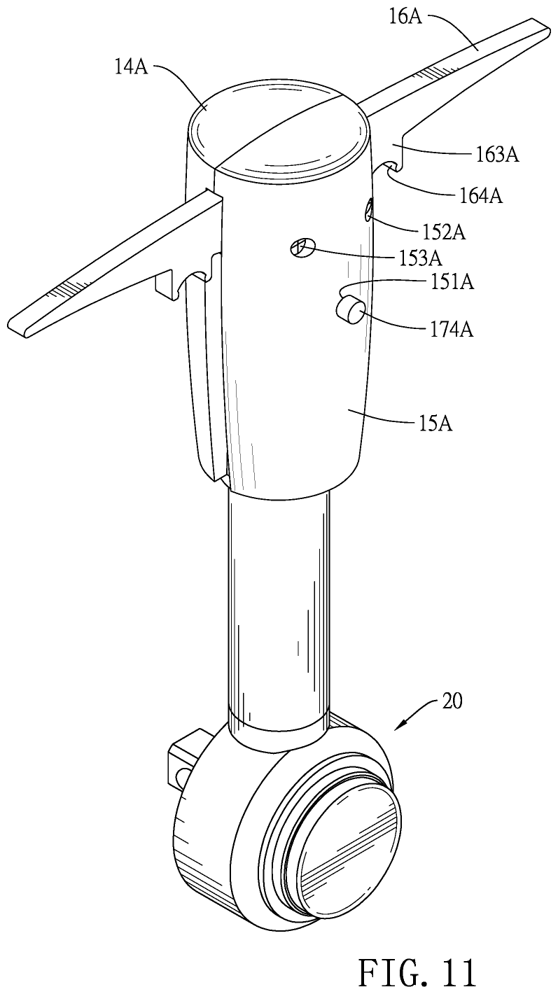

When the present invention is in use, the two rotating arms 16A have a folded status and an unfold status. As shown in FIGS. 8 to 11, when the two rotating arms 16A are in the folded status, the two rotating arms 16A are located in the first mounting recess 141A, and one end of each one of the rotating arms 16A protrudes from the base 14A to allow the user to pull out the rotating arms 16A using said ends. The hook portions 164A of the two rotating arms 16A are engaged with the engaging grooves 175A of the fixing assembly 17A. The resilient element 176A is compressed by the body 172A, which makes the stopping portion 173A abut against the two rotating arms 16A. In addition, the hook portion 164A and the engaging groove 312 are interlocked with each other to prevent the two rotating arms 16A from pivoting away from the base 10.

With reference FIG. 9 to FIG. 11, when the two rotating arms 16A are in the unfolded status, the user pulls the two rotating arms 16A away from the base 10, which forces the engaging portions 163A to disengage from the engaging grooves 175A, and unfolds the two rotating arms 16A to a horizontal status. When unfolding, the stopping portion 173A is forced by the resilient element 176A to move toward the middle of the two rotating arms 16A and abut against the coupling teeth 162A, thereby preventing the rotating arms 16A from pivoting toward the base 10 and maintaining the unfolded status. The resilient element 176A also forces the pressing portion 174A to protrude from the cover 15A via the through hole 151A.

In the unfolded status, the two rotating arms 16A are protruded from the cover 15A, allowing the user to hold the two rotating arms 16A to rotate the wrench. Because the two rotating arms 16A provide the user with a longer force arm than the grabbing portion 12A does, the two rotating arms 16A generate larger torque than the grabbing portion 12A when the forces exerted by the user are the same in magnitude, thereby saving effort.

When the wrench is no longer in use, the user can press the pressing portion 174A to compress the resilient element 176A and force the stopping portion 173A to separate from the two rotating arms 16A, so that the rotating arms 16A can be returned to the folded status.

In the present invention, the two rotating arms 16A have the folded status and the unfold status to allow the wrench to be folded into the grabbing portion 12A to reduce the size of the wrench for ease of storage. In addition, the wrench of the present invention can maintain the operating method of a conventional wrench. The user can choose a suitable method according to user needs.

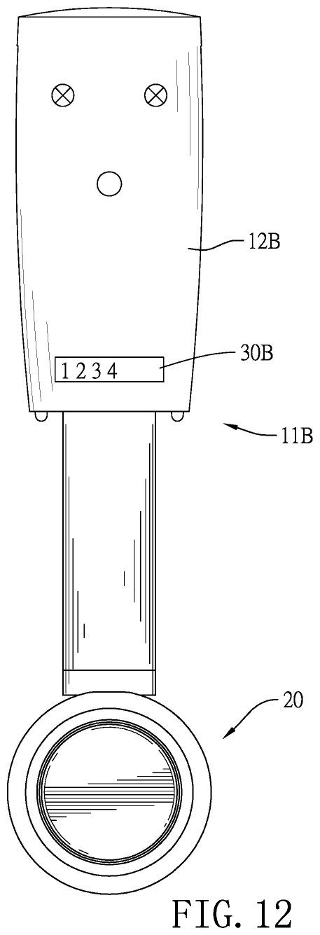

In a third embodiment, as shown in FIG. 12, a torque adjustment mechanism can be integrated with the main rod 11B. The torque adjustment mechanism is mounted inside the grabbing portion 12B. A torque indicator 30B of the torque adjustment mechanism is revealed on the grabbing portion 12B to accurately control the torque. The torque adjustment mechanism is a prior art.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wrench comprising:
a handle portion comprising
a main rod; and
a rotating rod; two opposite ends of the rotating rod being respectively a first end and a second end; the first end of the rotating rod fixed to the main rod; and
a head portion connected to the handle portion and comprising
an accommodating element having
an internal space;
a front opening;
a rear opening; the front opening and the rear opening respectively formed on two ends of the accommodating element; and
a side opening formed through a side wall of the accommodating element; and
an engaging portion extending outward from a periphery of the side opening and rotatably mounted around the main rod;
a sleeve mount rotatably mounted through the rear opening and the front opening of the accommodating element;
a driven gear mounted around the sleeve mount and located in the internal space of the accommodating element; the driven gear being a bevel gear; and
a driving gear mounted around the second end of the rotating rod and located in the internal space of the accommodating element; the driving gear being a bevel gear and engaged with the driven gear.

2. The wrench as claimed in claim 1, wherein
the accommodating element is a hollow cylinder or a hollow prism;
the periphery of the side opening is attached to the main rod.

3. The wrench as claimed in claim 1, wherein
the main rod further comprises
a connecting portion formed on one end of the main rod;
a first recess formed in the connecting portion; and
a second recess formed in a bottom of the first recess;
the rotating rod is mounted through the first groove and mounted in the second groove;
one end of the driving gear is mounted in the first recess;
an outer surface of the connecting portion is attached to the side opening of the accommodating element.

4. The wrench as claimed in claim 1, wherein the handle portion further comprises a grabbing portion; the grabbing portion is connected to the main rod and has
a base, being elongated and having
a mounting surface;
a first mounting recess formed in the mounting surface; the first mounting recess forming two arm openings on two opposite side surfaces of the base; and
a second mounting recess formed in the mounting surface;
wherein the first mounting recess is adjacent to the second mounting recess;
two areas of the first mounting recess extend along two opposite edges of an opening of the second mounting recess respectively;
a cover mounted on the mounting surface of the base; and
two rotating arms pivotally mounted in the first mounting recess and located between the base and the cover; the two rotating arms being elongated, and selectively protruding from the first mounting recess via the two arm openings or retracting into the first mounting recess.

5. The wrench as claimed in claim 4, wherein each one of the rotating arms extends along an imaginary straight line; when the two rotating arms protrude from the first mounting recess, the imaginary straight line of one of the two rotating arms is capable of being aligned with the imaginary straight line of another one of the two rotating arms.

6. The wrench as claimed in claim 4, wherein
the wrench further comprises a fixing assembly; the fixing assembly has:
a positioning element, having
a body, being a cylinder or a prism;
a stopping portion, being a block, protruding from a side wall of one end of the body and extending toward the two rotating arms;
a pressing portion, being a cylinder or a prism, formed on another end of the body; and
a resilient element pressing the positioning element against the base;
the base further has a third mounting recess formed in the mounting surface, and located among the two rotating arms and the second mounting recess;
the cover further has
a moving recess formed in a surface, which faces towards the base, of the cover and communicating with the third mounting recess and the first mounting recess;
a through hole formed in a bottom of the moving recess and formed through the cover; a position of the through hole corresponding to a position of the third mounting recess;
wherein
the positioning element is located in the moving recess and the third mounting recess and is movable;
the stopping portion of the positioning element selectively engages with the two rotating arms to stop the two rotating arms from pivoting;
the pressing portion of the positioning element protrudes from the cover via the through hole of the cover; and
the resilient element presses the positioning element to make the pressing portion protrude from the through hole.

7. The wrench as claimed in claim 6, wherein
each one of the two rotating arms forms at least one engaging portion;
multiple engaging grooves are formed in the body of the positioning element;
when the two rotating arms retract into the first mounting recess, the at least one engaging portion of each one of the two rotating arms engages with one of the engaging grooves.

8. The wrench as claimed in claim 7, wherein each one of the engaging portions is curved; each one of the engaging portions has two hook portions formed respectively on two ends of said engaging portion; the hook portions correspond in shape to the engaging grooves.

9. The wrench as claimed in claim 6, wherein
each one of the rotating arms forms multiple coupling teeth;
the coupling teeth of one of the rotating arms engage with the coupling teeth of another one of the rotating arms; and
the stopping portion selectively engages with the multiple coupling teeth of the two rotating arms to stop the two rotating arms from pivoting.

10. The wrench as claimed in claim 4, wherein
two locking holes are formed through the cover;
two screw holes are formed on the base and located at a bottom of the first mounting recess; positions of the two screw holes correspond to positions of the two locking components;
each one of the two rotating arms has
an end located between the cover and the base and forming a rotating hole;
the wrench includes two locking components; the two locking components are mounted through the two locking holes and the two rotating holes of the two rotating arms, and are fastened to the two screw holes to make each one of the rotating arms pivotally mounted via the corresponding locking components.

11. The wrench as claimed in claim 9, wherein a cross-sectional area of each one of the two rotating arms gradually decreases toward a direction away from the corresponding coupling teeth.

12. The wrench as claimed in claim 6, wherein the resilient element is a spring.

13. The wrench as claimed in claim 3, wherein
the rotating rod is a polygonal rod and the second recess is a polygonal recess;
a fixing hole is formed through the driving gear;
the fixing hole and the second recess correspond in shape to the rotating rod; an outer surface of the second end of the rotating rod is attached to an internal surface of the fixing hole.

14. The wrench as claimed in claim 1, wherein
the sleeve mount has a front positioning groove annularly formed in an outer surface of the sleeve mount; the front positioning groove is adjacent to the front opening;
the driven gear has a rear positioning groove annularly formed in an outer surface of the driven gear; the rear positioning groove is adjacent to the rear opening;
the head portion further comprises:
a front cover, being a hollow sheet, mounted to the sleeve mount and fixed to a periphery of the front opening of the accommodating element;
a front positioning piece, being a hollow sheet, mounted around the front positioning groove and attached to the front cover; and
a rear positioning piece, being a hollow sheet, mounted around the rear positioning groove and attached to the accommodating element.
